(19) United States
(12) Patent Application Publication
(10) Pub. No.: US 2025/0054183 A1
(43) Pub. Date: Feb. 13, 2025

(54) SYSTEMS AND METHODS FOR DRAFT CALCULATION

(71) Applicant: OMC INTERNATIONAL PTY LTD, Abbotsford, Victoria (AU)

(72) Inventors: Rowan MURCOTT, Abbotsford, Victoria (AU); Aidan D'SOUZA, Abbotsford, Victoria (AU)

(21) Appl. No.: 18/709,387

(22) PCT Filed: Nov. 11, 2022
(86) PCT No.: PCT/AU2022/051352

§ 371 Date: May 10, 2024

(30) Foreign Application Priority Data
Nov. 12, 2021 (AU) 2021903635

(51) Int. Cl. G06T 7/73; G01S 17/88; G06T 7/60; G06V 10/26; G06V 10/764; G06V 10/82; G06V 20/52

(52) U.S. Cl. CPC G06T 7/73; G01S 17/88; G06T 7/60; G06V 10/26; G06V 10/764; G06V 10/82; G06V 20/52; G06T 2207/20084; G06T 2207/30232; G06T 2207/30252

(57) ABSTRACT

The present disclosure provides new and innovative systems and methods for calculating the draft of a vessel. In an example, a computer-implemented method includes obtaining image data of a vessel, detecting at least one object in the image data, the at least one object comprising at least one draft mark, identifying a waterline by analysing the image data, determining an intersection between the at least one draft mark and the waterline, and calculating a height of the vessel based on the at least one draft mark and the intersection.

### CROSS-REFERENCE TO RELATED APPLICATION

This application is a National Stage of International Application No. PCT/AU2022/051352, filed Nov. 11, 2022, which claims priority to and the benefit of Australian Patent Application No. 2021903635, filed Nov. 12, 2021, the disclosures of which are incorporated herein by reference in its entirety.

### FIELD

The instant application relates to draft surveying of vessels and more specifically to image processing in surveying vessels.

### BACKGROUND

A vessel can be monitored to ensure it is not overloaded or unstable. This monitoring can be directed to any one of more vessel features, for example a height, a draft, or a list of the vessel among other things. Manual surveying of a vessel's height and/or draft during loading and unloading is time consuming and may require personnel to measure the height and/or draft of the vessel in a variety of weather conditions. The loading of the vessel may be interrupted by the surveying, increasing the time required to load the vessel.

### SUMMARY

The present disclosure provides new and innovative systems and methods for calculating the draft of a vessel. In an example, a computer-implemented method includes:
obtaining image data of a vessel,
detecting at least one object in the image data, the at least one object comprising at least one draft mark,
identifying a waterline by analysing the image data,
determining an intersection between the at least one draft mark and the waterline, and
calculating the draft of the vessel based on the at least one draft mark and the intersection.

For the purposes of this specification, the term “draft mark” is used to refer to a marking, or associated series of marks, located on a hull of the vessel. The marking, or series of markings, is generally disposed vertically, to provide a ‘ruler’-type arrangement, whereby the draft of the vessel (at that location on the hull) can be read from the point where the waterline reaches on that marking (or series of markings). The skilled person will understand that different styles of draft marks may be used within the context of the present invention, with different ways of representing the draft ‘ruler’. If the draft mark constitutes a series of markings, the present invention may interpolate between markings in the series, to accurately determine the draft represented by the intersection of the draft mark and the waterline.

The image data may be analysed by performing instance segmentation on the image data.

In an example, the computer-implemented method further includes obtaining the image data from at least one image sensor mounted to a dock. It should be noted that in some embodiments, the image sensors need not be mounted to a dock, e.g., if the vessel is at anchor.

The at least one object detected in the image data may comprise at least two draft marks. The at least two draft marks may be on the same side of the vessel. In this way, the trim of the vessel can be calculated.

In some embodiments, the at least one object detected in the image data may comprise three or more draft marks. The at least one object detected in the image data may comprise at least three draft marks. The at least three draft marks may be on the same side of the vessel. In this way, the hog or sag of the vessel can be calculated.

In an example, the computer-implemented method further includes determining an angle of list of the vessel. By determining the angle of list, the position of draft marks (relative to the waterline) may be estimated for the opposite side of the vessel from the at least one image sensor. In this way, the present invention enables the calculation of the overall draft of the vessel, without requiring surveyors to inspect both sides of the vessel. This is a significant advantage, as traditionally surveyors were required to inspect the vessel from both sides. However, inspection of the ocean side of the vessel often required that they use a smaller vessel to travel to the ocean side to manually observe the draft marks, sometimes in challenging water conditions that could prevent or inhibit accurate observation of draft marks. The present invention therefore can therefore enable more accurate, more reliable and more regular measurement of the overall draft of the vessel (including, in some examples, list, trim and/or hog or sag).

The angle of list may be determined by obtaining distance data in relation to the vessel. Distance data may be obtained at multiple points along the hull. This distance data may be obtained by using a distance sensor, such as a LIDAR, sonar or other type of sensor. The distance sensor(s) may be mounted to the dock. Alternatively, distance data could be obtained by other techniques, such as photogrammetry. Distance data may be obtained at multiple points along the hull, which enables the angle of list to be calculated at each of those multiple points. In this case, the present invention may comprise calculating a measure of torsion or flexion of the vessel, which may be based on the calculated angles of list.

The computer-implemented method may include identifying a trackable feature or reference point (such as a top edge) of the vessel using a distance sensor (such as a LIDAR sensor) and subsequently calculating the height of the vessel based on the trackable feature. Trackable features may also be used to calculate other measures of the way the vessel is sitting in the water (such as draft or angle of list), to monitor changes in those features over time, or as a backup or “sanity check” for those measures calculated using the present invention. For the purposes of this specification, the term “height” is used to refer to a height of the vessel, or height of a particular feature, above the waterline.

In an example, the image data is analysed using instance segmentation, which may be performed using a deep learning model or convolutional neural network. The instance segmentation allows each object instance for every known object within an image to be identified.

In an example, the instance segmentation is performed using a Mask R-CNN machine classifier. This form of instance segmentation detects the number of objects of an image (detection) and groups the pixels of the image into meaningful groups (semantic segmentation), for example the groups may comprise, water, sky, vessel hull, and draft marks, allowing objects of the image to be classified and localized using a bounding box.

In an example, instance segmentation may be performed using a segmentation convolutional neural network such as Cascade Mask R-CNN, YOLACT or detectron2, and may include real-time, single shot, instance segmentation. Two stage detection models and anchor free models may also be used.

In an example, the at least one object is detected using a Faster R-CNN machine classifier. Faster R-CNN assigning a class label and a bounding box offset to each candidate object within an image.

In an example, the at least one object may be detected using a convolutional neural network such as EfficentDet, YOLO (You Only Look Once), YOLOX or ConvNeXT.

In another example of the present invention, there is provided a survey system for calculating the draft of a vessel, comprising:
one or more image sensors to obtain image data of a vessel; and
a controller in communication with the one or more image sensors, to calculate the draft of the vessel.

The controller may be configured to:
detect at least one object in the image data, the at least one object comprising at least one draft mark,
identify a waterline by analysing the image data,
determine an intersection between the at least one draft mark and the waterline, and
calculate the draft of the vessel based on the at least one draft mark and the intersection.

The survey system may further comprise a distance sensor to obtain distance data. The distance sensor may be a LIDAR sensor, and the distance data may be LIDAR data, although different types of sensors may be used in different embodiments of the invention (e.g., acoustic/SONAR sensors). The controller may be configured to calculate a height of the vessel, and/or the list of the vessel, and/or the trim of the vessel, and/or the hog/sag of the vessel, and/or torsion or flexion of the vessel based on the image data and/or the distance data.

In another example of the present invention, there is provided a computer-implemented method comprising:
receiving image data of a vessel from at least one image sensor,
detecting at least one object in the image data, the at least one object comprising at least one draft mark,
identifying a waterline by analysing the image data,
determining an intersection between the at least one draft mark and the waterline, and
calculating the draft of the vessel based on the at least one draft mark and the intersection.

The method may further comprise receiving distance data of the vessel. The distance data may be received from one or more distance sensors. The method may further comprise calculating the height and/or list of the vessel based on the distance data. The method may further comprise identifying drift of the vessel.

In another example of the present invention, there is provided a computer system comprising a memory, and at least one processor configured to perform one of the computer-implemented method(s) described above.

Additional features and advantages of the disclosed method and apparatus are described in, and will be apparent from, the following detailed description and the figures. The features and advantages described herein are not all-inclusive and, in particular, many additional features and advantages will be apparent to one of ordinary skill in the art in view of the figures and detailed description. Moreover, it should be noted that the language used in the specification has been principally selected for readability and instructional purposes, and not to limit the scope of the inventive subject matter.

### BRIEF DESCRIPTION OF THE DRAWINGS

The description will be more fully understood with reference to the following figures, which are presented as exemplary aspects of the disclosure and should not be construed as a complete recitation of the scope of the disclosure, wherein:

FIG. 1 illustrates a block diagram of an operating environment according to an example aspect of the present disclosure;

FIG. 2 illustrates a block diagram of a computing device according to an example aspect of the present disclosure;

FIGS. 3A-B are illustrations of sensor locations within an operating environment according to example aspects of the present disclosure;

FIG. 4 is an image of draft marks on a vessel according to an example aspect of the present disclosure;

FIGS. 5A-B are illustrations of classified image data according to example aspects of the present disclosure; and

FIG. 6 illustrates a flowchart of a process for calculating the draft of a vessel according to an example aspect of the present disclosure.

### DETAILED DESCRIPTION

With reference to the drawings, techniques are disclosed for new and innovative systems and methods for calculating the draft of a vessel. Large vessels typically have draft marks, which are characters present on the hull, indicating the relative vertical distance between the keel of the vessel and the characters themselves. These draft marks offer a quick and simple reference to infer a vessel's submersion underwater. Typical draft surveys use a manual visual inspection to determine the current position of a vessel based on the inspection of the waterline against the hull. Large vessels commonly have six sets of draft marks—two at the bow, two at the mid, and two at the stern. To account for vessel trim, two sets of draft marks on one side of the vessel can be read. To account for vessel list, draft marks on both sides of the vessel are ordinarily read by surveyors, who typically use a smaller vessel to inspect the ocean side of the vessel. In still waters, this task can be rather simple, but even small swells and wave activity can make this difficult and introduce measurement errors. Larger swells, off-shore berths, and/or rain or fog can further complicate inspections and be potentially dangerous for staff. Furthermore, impartiality in reading the draft marks can never be guaranteed by a human observer. Even small offsets in draft measurements can result in product oversights and losses. Typical instruments, such as tide gauges and portable pilot units, offer high accuracy sensor data to help calculate positional information of a vessel, but do not offer visual evidence of a vessel's draft.

Draft survey devices and systems according to the present invention provide an automated means to safely and accurately determine the draft of a vessel regardless of environmental conditions. During the loading stages of a vessel, draft survey devices of the present invention can capture images of the vessel. These draft survey devices can use a variety of computer vision processes and/or machine classifiers to automatically identify the draft marks, waterline, and calculate the vessel's draft. This removes any potential bias in the readings as well as eliminating physical risk to staff who would usually perform these readings. Additionally, these processes can adapt to differences in the color, shapes, fonts, etc. of draft marks on vessels and variations in the water color. This visual information is relatively quick and easy to be validated and understood to confirm the accuracy of the determined draft.

Draft survey devices according to the present invention provide a variety of improvements to existing devices and techniques for measuring the draft of a vessel. Draft survey devices according to the invention can analyze individual frames of video streams to log draft readings for a given period of time, thereby providing faster and more accurate measurements of a vessel draft irrespective of weather conditions. Additionally, the captured images and output from the draft survey devices can be quickly and efficiently validated, which is not possible with existing human observation techniques. Draft survey devices and systems of the present invention are also capable of providing accurate measurements irrespective of variations in vessel design, draft marks, and water conditions. In contrast, typical devices are unable to accurately determine a waterline and/or account for variations in vessel design. In this way, draft survey devices in accordance with embodiments of the invention improve on the capabilities of the devices themselves to accurately and efficiently determine the draft for a vessel in a variety of environmental conditions.

Other advantages that may be provided by various embodiments of the present invention include the simultaneous measurement of draft marks (not possible with a single surveyor performing manual readings of the draft marks); continuous measurement/monitoring of the vessel draft, while it is at the dock, and while it is being loaded (not accomplished by a single surveyor inspecting the draft at significantly spaced intervals); the reduction or avoidance of the need to board the vessel, to determine how the vessel is sitting in the water; the reduction or avoidance of loading stoppages to allow for manual surveying of the vessel; the expedition of final surveys to determine “final trim” of the vessel, due to the continuous measurement of vessel draft during the loading process; improved safety and/or speed advantages associated with the above; and a reviewable log of the vessel draft measurements while in dock and during loading, that can be reviewed at a later date if further investigations are required.

A variety of computing systems and processes for calculating the draft of a vessel in accordance with aspects of the disclosure are described in more detail herein.

### Operating Environments and Computing Devices

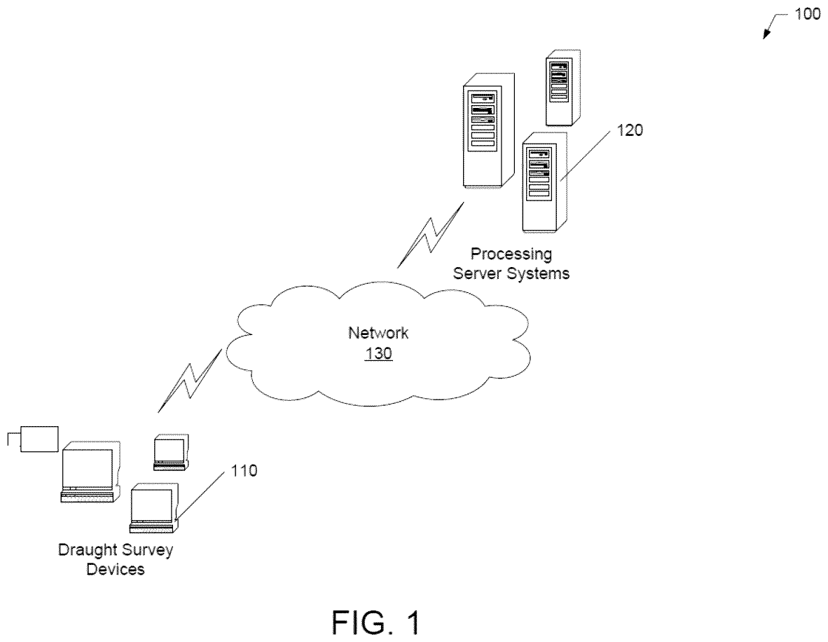

FIG. 1 illustrates a block diagram of an operating environment 100 in accordance with one or more aspects of the present disclosure. The operating environment 100 can include draft survey devices 110 and/or processing server systems 120 in communication via network 130. In many aspects, the processing server systems 120 are implemented using a single server. In a variety of aspects, the processing server systems 120 are implemented using a plurality of servers. In several aspects, draft survey devices 110 are implemented utilizing the processing server systems 120. In a variety of aspects, processing server systems 120 are implemented using the draft survey devices 110.

Draft survey devices 110 can obtain data regarding the position of a vessel and/or determine the draft of the vessel as described herein. Processing server systems 120 can obtain data regarding the position of a vessel from draft survey devices 110 and/or determine the draft of the vessel as described herein. Any data described herein can be transmitted between draft survey devices 110 and/or processing server systems via network 130. The network 130 can include a LAN (local area network), a WAN (wide area network), telephone network (e.g., Public Switched Telephone Network (PSTN)), Session Initiation Protocol (SIP) network, wireless network, point-to-point network, star network, token ring network, hub network, wireless networks (including protocols such as EDGE, 3G, 4G LTE, Wi-Fi, 5G, WiMAX, and the like), the Internet, and the like. A variety of authorization and authentication techniques, such as username/password, Open Authorization (OAuth), Kerberos, SecureID, digital certificates, and more, may be used to secure the communications. It will be appreciated that the network connections shown in the operating environment 100 are illustrative, and any means of establishing one or more communications links between the computing devices may be used.

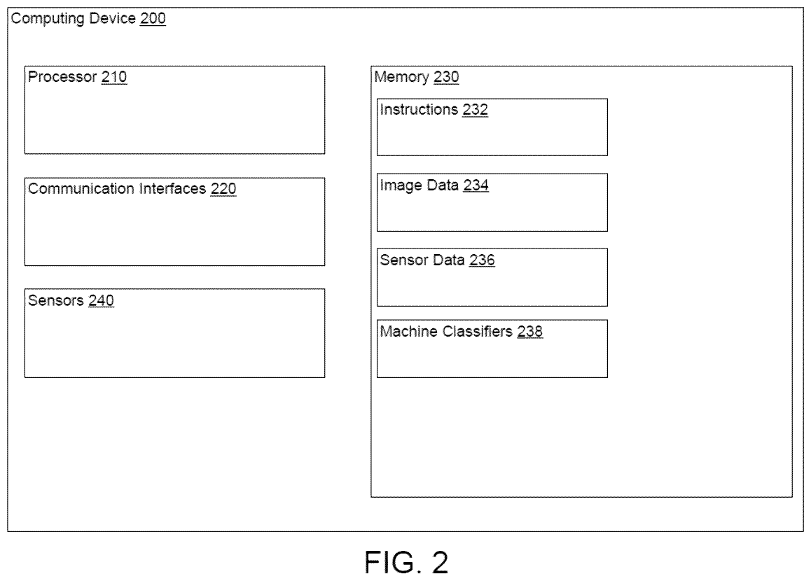

Any of the devices shown in FIG. 1 (e.g., draft survey devices 110 and processing server systems 120) can include a single computing device, multiple computing devices, a cluster of computing devices, and the like. A conceptual illustration of a computing device in accordance with an embodiment of the invention is shown in FIG. 2. The computing device 200 includes a processor 210 in communication with memory 230. The computing device 200 can also include one or more communication interfaces 220 capable of sending and receiving data and one or more sensors 240 capable of capturing data. In a number of embodiments, the communication interface 220 and/or sensors 240 are in communication with the processor 210 and/or the memory 230. In several embodiments, the memory 230 is any form of storage storing a variety of data, including, but not limited to, instructions 232, image data 234, sensor data 236, and/or machine classifiers 238. In many embodiments, instructions 232, image data 234, sensor data 236, and/or machine classifiers 238 are stored using an external server system and received by the computing device 200 using the communications interface 220. The processor 210 can be directed, by the instructions 232, to perform a variety of model generation processes based on the image data 234, sensor data 236, and/or machine classifiers 238 as described herein.

The processor 210 can include one or more physical processors communicatively coupled to memory devices, input/output devices, and the like. As used herein, a processor may also be referred to as a central processing unit (CPU). Additionally, as used herein, a processor can include one or more devices capable of executing instructions encoding arithmetic, logical, and/or I/O operations. In one illustrative example, a processor may implement a Von Neumann architectural model and may include an arithmetic logic unit (ALU), a control unit, and a plurality of registers. In many aspects, a processor may be a single core processor that is typically capable of executing one instruction at a time (or process a single pipeline of instructions) and/or a multi-core processor that may simultaneously execute multiple instructions. In a variety of aspects, a processor may be implemented as a single integrated circuit, two or more integrated circuits, and/or may be a component of a multi-chip module in which individual microprocessor dies are included in a single integrated circuit package and hence share a single socket. Memory 230 can include a volatile or non-volatile memory device, such as RAM, ROM, EEPROM, or any other device capable of storing data. Communication devices 220 can include network devices (e.g., a network adapter or any other component that connects a computer to a computer network), a peripheral component interconnect (PCI) device, storage devices, disk drives, printer devices, keyboards, displays, etc. Sensors 240 can include sound or video adaptors, still imaging devices, video imaging devices, radar devices, LIDAR devices, two-dimensional scanners, three-dimensional scanners, and/or any other device capable of capturing data regarding a vessel and/or its environment.

Although specific architectures for computing devices in accordance with embodiments of the invention are conceptually illustrated in FIG. 2, any of a variety of architectures, including those that store data or applications on disk or some other form of storage and are loaded into memory at runtime, can also be utilized. Additionally, any of the data utilized in the system can be cached and transmitted once a network connection (such as a wireless network connection via the communications interface) becomes available. In several aspects, the computing device 200 provides an interface, such as an API or web service, which provides some or all of the data to other computing devices for further processing. Access to the interface can be open and/or secured using any of a variety of techniques, such as by using client authorization keys, as appropriate to the requirements of specific applications of the disclosure. In a variety of embodiments, a memory includes circuitry such as, but not limited to, memory cells constructed using transistors, that store instructions. Similarly, a processor can include logic gates formed from transistors (or any other device) that dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices.

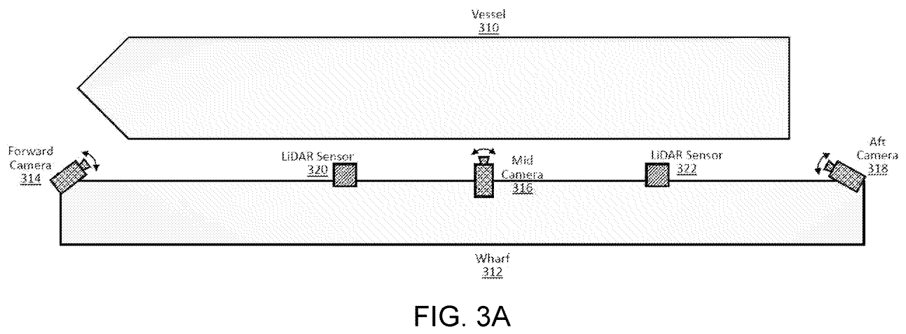

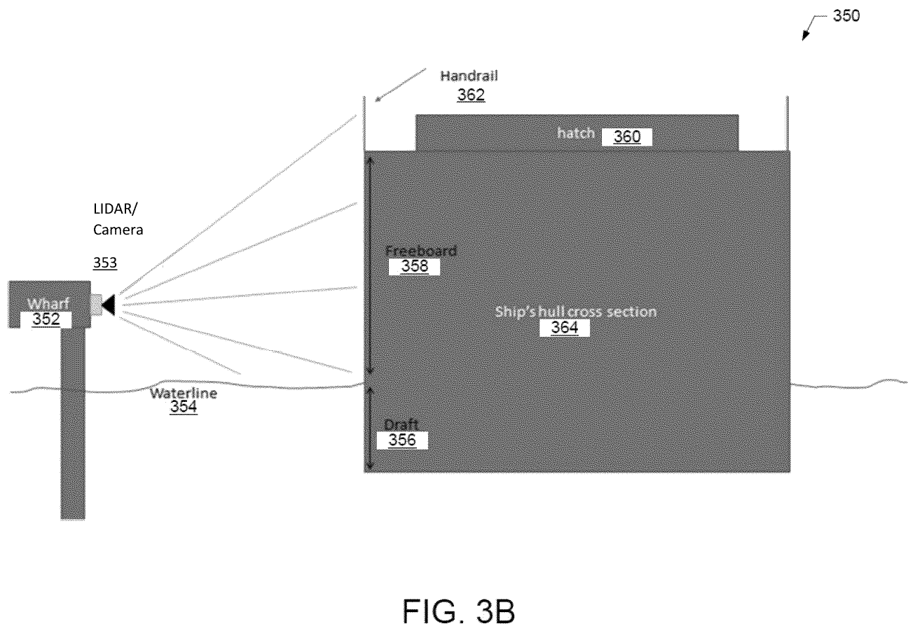

Draft survey devices can use a variety of sensors to capture information regarding the location of a vessel. FIGS. 3A-B are illustrations of sensor locations within an operating environment according to example aspects of the present disclosure. Turning now to FIG. 3A, an overhead view of sensors located in a wharf in accordance with an example aspect of the disclosure is shown. The view 300 includes a vessel 310 located in a wharf 312. The wharf 312 has three cameras (and may use more), one located at the stern (314), one located at midship (316), and one located at the bow of the vessel (318). The wharf 312 also has two LIDAR sensors (and may use more), a first LIDAR sensor (320) located between the stern camera (e.g., forward camera) and the midship camera and a second LIDAR sensor (322) located between the midship camera and the bow camera (e.g., aft camera). The cameras (314, 316, 318) and sensors (320, 322) can be mounted to various locations on the wharf 312.

Turning now to FIG. 3B, a conceptual illustration of a cross-section of sensor locations with respect to a vessel 364 in accordance with an aspect of the disclosure is shown. The view 350 includes a wharf 352 having a mounted sensor 353 (e.g., a camera and/or LIDAR sensor). The sensors (353) can capture data regarding the waterline (354) and a trackable feature to determine a measure of the height of the vessel 364, such as the freeboard (358) (if the deck is visible) or other measure of height such as the portion of the vessel above the waterline, to the top of the handrail. Other trackable features of the vessel (364) may be used in accordance with embodiments of the invention. The data captured by sensors (353) can include image data and/or sensor/distance data (such as a mesh or point cloud data) regarding the vessel and the environment. In several embodiments, the freeboard (358) is calculated, or the full height to the top of a handrail (362) of the vessel 364. Based on this information (i.e., the image data captured from the cameras (314, 316, 318) and the LIDAR data captured from the LIDAR sensors (320,322)), the draft (356) of the vessel 364, and preferably other measurements of the way the vessel (364) is sitting in the water, can be calculated using a variety of processes as described in more detail herein. The height of the trackable feature may be tracked over time.

A variety of camera and/or sensor placements are shown in FIGS. 3A-B. However, it should be noted that any number of cameras and/or LIDAR sensors and any positioning of the cameras and/or LIDAR sensors can be used in accordance with embodiments of the invention. The cameras (314, 316, 318), in particular, may be movable along the wharf (e.g., on rails), and/or may be swiveled up or down or side-to-side on their mounts, to help locate and read draft marks on the vessel. In some embodiments, the sensors (320, 322) may also be movable, although this may require recalibration of the sensors (320, 322) when they move to a new position. In some embodiments, different types of sensors may be used, such as RADAR, sonar (acoustic) or other sensors, to obtain data regarding the position and alignment of the vessel (in particular the side of the vessel, typically the wharf side of the vessel, in accordance with embodiments of the present invention).

Mounting of the cameras (314, 316, 318) and/or sensors (320, 322) may include features such as cleaning apparatus (to clean the cameras or sensors at regular intervals, or when dirt is detected) or sun shades to reduce sun glare, which may result in lens flare impairing camera performance. Sun shades could be fixed in place, or configured to be positionable e.g., depending on the location of the sun.

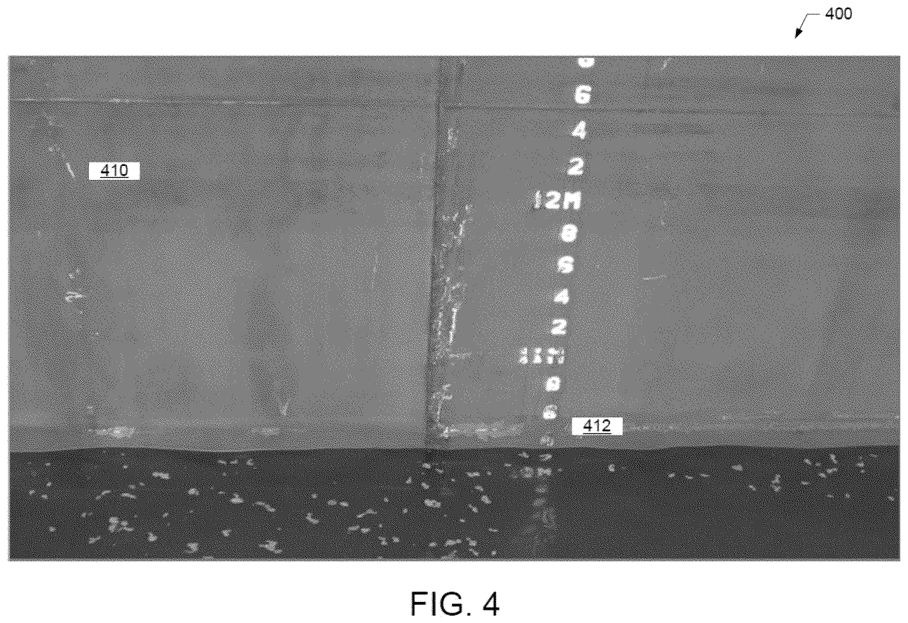

Vessels include one or more sets of draft marks. The draft marks indicate the vertical distance between the waterline and a bottom of the hull of the vessel. The draft marks include a scale marked on the hull from bow and to stern. The scale may use traditional Imperial units or metric units. For Imperial units, the bottom of each marking is the draft in feet and markings are 6 inches high. For metric units, the bottom of each draft mark is the draft in decimeters and each mark is one decimeter high. FIG. 4 is an image of draft marks on a vessel according to an example aspect of the present disclosure. As shown in image 400, a vessel 410 is located in water, with a waterline being between 10.2 and 10.4 meters as indicated by the draft marks (412) on the side of the vessel.

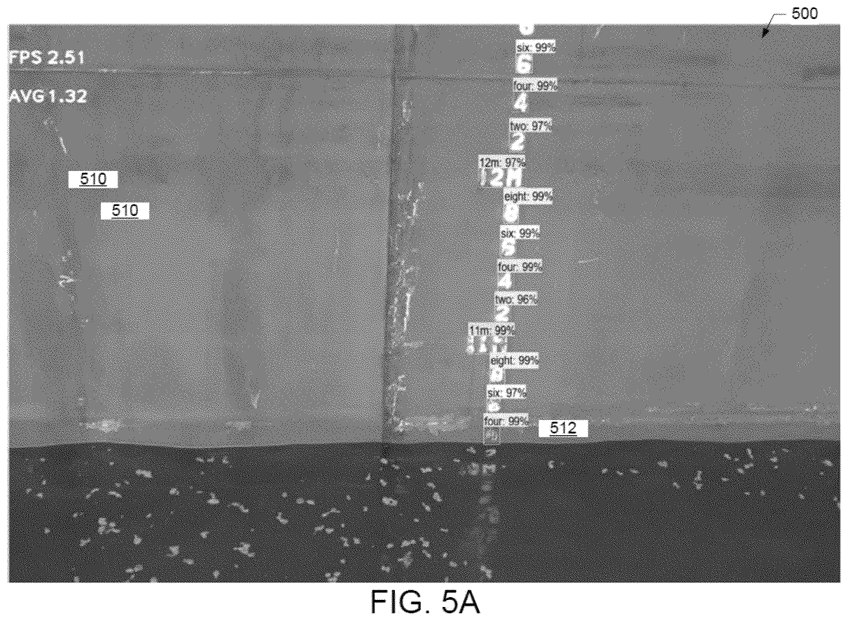

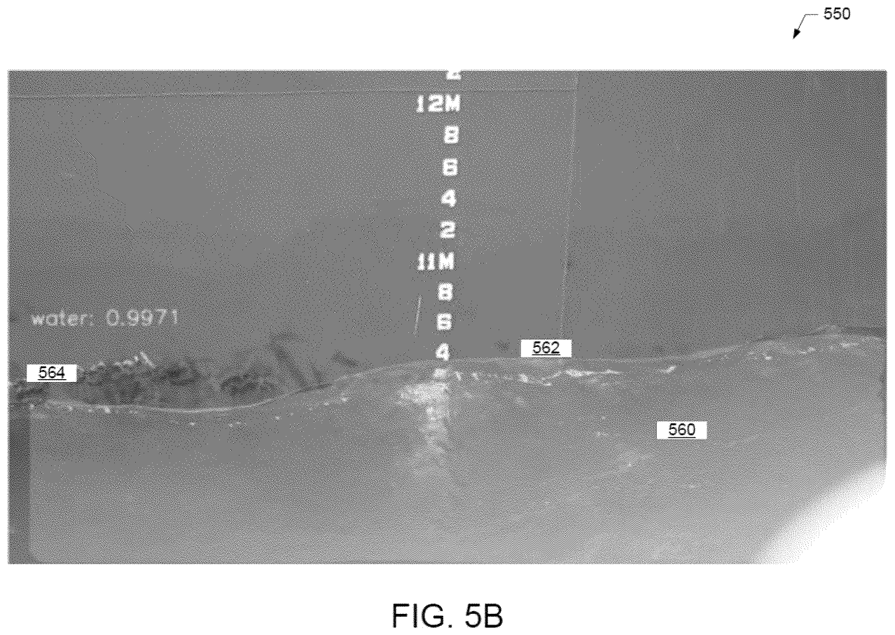

A waterline and draft marks can be identified and used to calculate the draft of the vessel using a variety of techniques as described herein. FIGS. 5A-B are illustrations of classified image data according to example aspects of the present disclosure. Turning now to FIG. 5A, a classified image 500 showing identified draft marks (512) in accordance with an example aspect of the disclosure is shown. The image 500 includes the draft marks 512, where each visible draft mark 512 has been classified as a number and a confidence metric indicating the likelihood that the number has been classified correctly. For example, the number ‘4’ just above a waterline has been labeled as a “four” with 99% confidence.

Turning now to FIG. 5B, a classified image 550 showing the identified waterline (562) in accordance with an example aspect of the disclosure is shown. The image 550 includes the detected water (indicated as region 560) along with a confidence metric indicating the likelihood that the upper edge of the detected water corresponds to the true waterline as shown in the image 550. In the illustrated example, the waterline (562) has been detected with a confidence of 99.71% (as indicated in the left-hand side of the image). In particular, it should be noted that the waterline (562) has been clearly detected and the water has not been confused with the rust and markings 564 on the hull of the vessel on the left-hand side of the image 550.

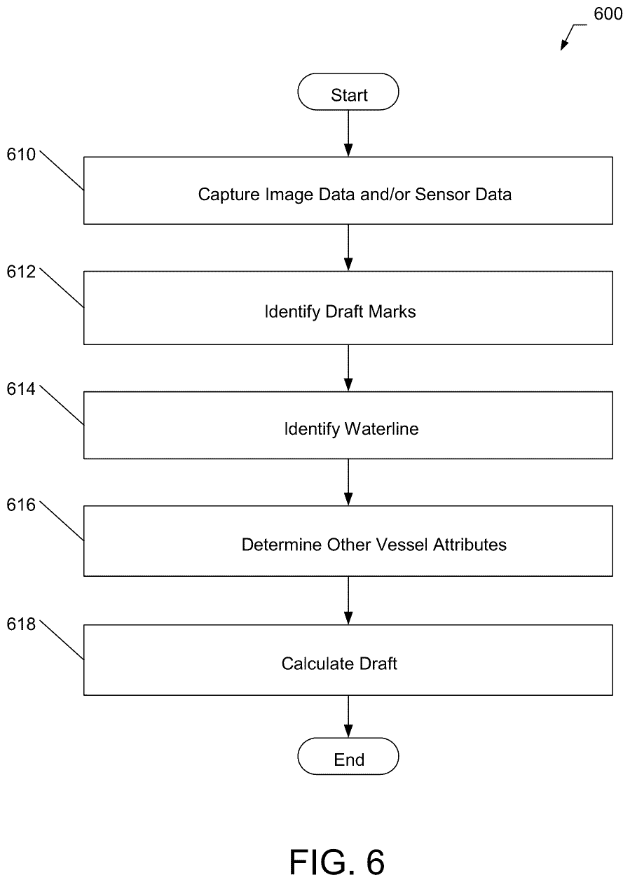

Draft survey devices according to the present invention can use a variety of computer vision and/or machine classifiers to identify draft marks, a waterline, and/or calculate a draft for a vessel. FIG. 6 illustrates a flowchart of a process for calculating the draft of a vessel according to an example aspect of the present disclosure. Although the process 600 is described with reference to the flowchart illustrated in FIG. 6, it will be appreciated that many other methods of performing the acts associated with the process 600 may be used. For example, the order of some of the blocks may be changed, certain blocks may be combined with other blocks, one or more blocks may be repeated, and some of the blocks described are optional. The process 600 may be performed by processing logic that may include hardware (circuitry, dedicated logic, etc.), software, or a combination of both.

Image data and/or sensor data can be captured (610). The image data can be captured using one or more image sensors mounted on a wharf as described herein. The image data can include one or more images (e.g., still images, a sequence of images, and/or video data) of a vessel located in a body of water. The sensor data can include data regarding the vessel and/or the surrounding environment, including distance data such as data captured using a LIDAR sensor (LIDAR data). In many embodiments, the sensor data includes a point cloud, where each point in the point cloud indicates a distance and angle from the sensor to the water and/or hull of the vessel. The present invention may include filtering the distance data, to exclude noise (for instance intermittent reflections off the water surface). The point cloud can be two dimensional and in some embodiments, three dimensional.

Draft marks can be identified (612). The draft marks can be indicated on the hull of the vessel. Identifying the draft marks can include detecting one or more objects within the image data and classifying the detected objects using one or more machine classifiers. In several embodiments, the identified draft marks further include a confidence metric indicating the likelihood that the label assigned to the identified draft mark corresponds to the ground truth label for the draft mark. Machine classifiers are particularly well suited to identifying the draft marks as the draft marks can be of a variety of sizes, shapes, and colors contrasted against a hull of varying colors. In a number of embodiments, the machine classifier uses a Faster Region-Based Convolutional Neural Network (Faster R-CNN) architecture, although any of a variety of machine classifiers can be utilized as described herein. The system is preferably trained or configured to read draft marks from a variety of angles, and at a variety of distances, and in a variety of conditions, to accommodate different sizes and curvatures of vessels, and to accommodate vessels located at different points along the dock. Images may be used from a variety of such conditions, or may be distorted or recoloured in a multitude of representative ways to help train the system to better recognise draft marks. In addition, the recognition of draft marks may be performed even for draft marks in different fonts, capital and lower-case meter marks, and metric and imperial measures. The system may be trained to recognise draft marks in a variety of conditions. If a draft mark cannot be recognised, this may be flagged and a responsible person alerted—this may, for instance, indicate that the draft mark(s) need to be cleaned.

The machine classifiers can be trained to identify draft marks using a variety of training data. The training data can include images of vessels in water with labels indicating the ground truth label for one or more draft marks in the images. The training data can include images for multiple vessels and multiple wharfs such that the training data represents different vessels in the same wharf and the same vessel in different wharfs, thereby improving the capability of the machine classifier to identify a particular vessel in a variety of different environments. In several embodiments, the machine classifiers can be retrained based on additional images of a particular vessel.

A waterline can be identified (614). The waterline can indicate the intersection of the vessel's hull with the water. In many embodiments, a machine classifier can detect the body of water and identify the topmost edge of the contour of the body of water as the waterline. The machine classifier can also generate a confidence metric indicating the likelihood that the detected body of water corresponds to the actual water. In a variety of aspects, the machine classifier can use a Mask Region Proposal Convolutional Neural Network (Mask R-CNN) architecture, but any of a variety of machine learning classifiers can be utilized as described herein. The machine classifier can detect the body of water by identifying an object in the image and performing a pixel-wise detection to isolate the water object and form an accurate model of the edges of the object. In several embodiments, the machine classifier utilizes multiple images (such as successive images in a video of the vessel) to detect an absolute difference in pixels between the images to identify the contours of the water object.

The machine classifier can be trained to identify waterlines using a variety of training data. The training data can include images of vessels in water with labels indicating the ground truth contours for the waterline in the images. The training data can include images for multiple vessels, multiple wharfs, and multiple environmental conditions such that the training data represents different vessels in the same wharf and the same vessel in different wharfs, each in a variety of weather conditions, thereby improving the capability of the machine classifier to identify a waterline in a variety of different environments. In several embodiments, the machine classifiers can be retrained based on additional images of a vessel and waterline to refine the ability of the machine classifier to correctly identify waterlines.

It should be readily apparent to one having ordinary skill in the art that a variety of machine classifiers can be utilized including (but not limited to) decision trees, k-nearest neighbors, support vector machines (SVM), neural networks (NN), recurrent neural networks (RNN), convolutional neural networks (CNN), and/or probabilistic neural networks (PNN). RNNs can further include (but are not limited to) fully recurrent networks, Hopfield networks, Boltzmann machines, self-organizing maps, learning vector quantization, simple recurrent networks, echo state networks, long short-term memory networks, bi-directional RNNs, hierarchical RNNs, stochastic neural networks, and/or genetic scale RNNs. In a number of embodiments, a combination of machine classifiers can be utilized, more specific machine classifiers when available, and general machine classifiers at other times can further increase the accuracy of predictions. In a variety of embodiments, a database of vessels can be used to determine the draft mark type (including imperial and metric type, and also variations in font). A vessel can be identified by its AIS transponder and the appropriate machine classifer(s) can be selected for the vessel.

One or more other attribute(s) of the vessel may be determined (616), such as the vessel list, hog or sag, flexion or torsion, and/or height. In some embodiments, a vessel freeboard or other measure of height can be determined. The height may be a measure of the height from the waterline to the top of the vessel. In many embodiments, the height is calculated using a machine classifier to identify the top edge of the hull of the vessel and/or a handrail in the image data. In a number of embodiments, the height is calculated based on a point cloud captured using a LIDAR sensor. The height may be used as a proxy for the draft, or as a sanity check against draft measurements determined from the image data. Changes in height measurements may be cross-checked with changes in draft, and may be compared to technical specifications of the particular vessel and/or tidal data to keep more accurate/up-to-date measurements of the way the vessel is sitting in the water. The height information may be used as a redundancy (e.g., for short times) during periods where the draft cannot be determined from the image data (e.g., if cameras become dirty or defective, if conditions are particularly difficult to read draft marks, or if the draft marks being dirty).

An angle of list can also be determined for the vessel. A line of best fit can be calculated based on the point cloud and the angle of that line of best fit from the vertical can be used as the angle of list for the vessel. In a variety of embodiments, the best-fit function includes a probabilistic Hough transform to identify a Hough line and perform a linear regression to calculate the angle. In several embodiments, a Hough transform is used as a first pass filter, which identifies the hull, defining its location. A bounding box can be defined based on the location of the Hough line and point cloud data that falls within that bounding box can be used in the linear interpolation calculation. In a variety of embodiments, the angle can be used to calibrate the angle of the LIDAR sensors and/or image sensors.

Calibration of the LIDAR sensors (or other distance sensors) can be done when they are mounted. These sensors generally are calibrated relative to a horizontal plane. Depending on the particular distance sensor, the horizontal may be determined by reference to the waterline, based on measurements of the water surface collected and averaged over time (e.g., if the distance sensor is able to obtain measurements off the water). In other embodiments, manual calibration from a set horizontal calibration surface may be used. In some embodiments, regular calibration of the LIDAR is performed on an ongoing basis to enable “continuous” calibration of the LIDAR sensors.

A draft can be calculated (618). The draft can be calculated based on the identified draft marks and the identified waterline. In a variety of embodiments, the draft is calculated based on the intersection of the line formed by the detected draft marks and the waterline. Based on the label of the corresponding draft mark and the size of the draft mark, the draft can be calculated for the vessel. In several embodiments, multiple draft calculations can be aggregated to calculate an averaged draft for the vessel. In many embodiments, the height can be used as a sanity check against sudden changes in the draft. In several embodiments, the angle of list can be used to determine the draft on the opposing side of the vessel (i.e., by using the draft on the sensor-side of the vessel, the location of the draft marks relative to the waterline can be estimated or proxied by taking into account the list of the vessel).

In addition to calculating the draft of a vessel, the information generated using the draft survey devices can be used in a variety of other contexts. For example, the image data and/or sensor data can be used to determine the orientation of the imaging devices and/or sensors. The calculated draft can be combined with a variety of characteristics of the vessel to calculate the displacement of the vessel and/or the amount of cargo loaded on the vessel at a particular time. Further, the data can be used to measure vessel movements at berth (e.g., wave response and drift), which can be used to maintain and/or place mooring lines to help keep the vessel at berth.

In some embodiments a height of the vessel can be determined and/or tracked using the computer-implemented method of the invention. In a simple embodiment, the method may comprise obtaining a point cloud of two or more points of sensor data (although using current LIDAR sensors, thousands of points may be obtained), and calculating a line of best fit to determine an angle of the near wall of the vessel. In many instances, the side walls of the vessel may be considered to be straight and parallel to each other, and so this angle (relative to the perpendicular) corresponds to the list of the vessel. As previously described, the angle of list may be used to estimate or proxy draft readings for the opposite side of the vessel.

The method may further comprise determining the height of the vessel at several locations by tracking features identified via visual recognition (e.g., draft marks or a transom or top edge of the vessel) via a 2D or a 3D LIDAR point cloud. The shape of the vessel's hull, including flexion and torsion thereof, can then be inputted to a computer-model by fitting a curve or curves to the location of the selected tracking feature or features. In one example this model can be a 3D or 2D representation of the hull. The model is then used to determine via interpolation and/or extrapolation the height along any point of the vessel's hull when a direct measurement is not available. A further exemplary tracking feature identified via LIDAR point cloud is the top edge of the vessel. These trackable features of the vessel may be tracked in real time, and tidal data may also be received in real time and used to more accurately track the height of the trackable feature over time.

An example of a feature identified via LIDAR point cloud is the transom of the vessel. The plane of the transom can be identified via Hough transform. An appropriate point or edge of the transom is then tracked to determine a change in height of the vessel at that location.

Embodiments of the present invention may also be used to flag discrepancies identified during vessel loading, or at any time while the vessel is at the dock (or at anchor). For example, vessel drift may be monitored and an alarm raised if it is outside acceptable bounds.

It will be appreciated that all of the disclosed methods and procedures described herein can be implemented using one or more computer programs, components, and/or program modules. These components may be provided as a series of computer instructions on any conventional computer readable medium or machine-readable medium, including volatile or non-volatile memory, such as RAM, ROM, flash memory, magnetic or optical disks, optical memory, or other storage media. The instructions may be provided as software or firmware and/or may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures. As will be appreciated by one of skill in the art, the functionality of the program modules may be combined or distributed as desired in various aspects of the disclosure.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced otherwise than specifically described without departing from the scope and spirit of the present disclosure. Thus, embodiments of the present disclosure should be considered in all respects as illustrative and not restrictive. It will be evident to the annotator skilled in the art to freely combine several or all of the embodiments discussed here as deemed suitable for a specific application of the disclosure. Throughout this disclosure, terms like “advantageous”, “exemplary” or “preferred” indicate elements or dimensions which are particularly suitable (but not essential) to the disclosure or an embodiment thereof, and may be modified wherever deemed suitable by the skilled annotator, except where expressly required. Accordingly, the scope of the invention should be determined not by the embodiments illustrated, but by the appended claims and their equivalents.

In this specification and the incorporated provisional specification, alternate spellings “draft” and “draught” are used interchangeably to denote the same feature.

1-20. (canceled)

21. A computer-implemented method, comprising:
obtaining image data of a vessel;
detecting at least one object in the image data, the at least one object comprising at least one draft mark;
identifying a waterline by analysing the image data;
determining an intersection between the at least one draft mark and the waterline;
obtaining distance data of the hull of the vessel from one or more distance sensors; and
determining an angle of list of the vessel, based on the distance data; and
calculating a draft of the vessel based on the at least one draft mark and the intersection, and the angle of list.

22. The computer-implemented method of claim 21, further comprising estimating the position of one or more draft marks relative to the waterline, for an opposite side of the vessel.

23. The computer-implemented method of claim 22, wherein the distance data comprises LIDAR data and the one or more distance sensors comprise one or more LIDAR sensors.

24. The computer-implemented method claim 21, further comprising determining a height of the vessel.

25. The computer-implemented method of claim 24, wherein the height is determined from the distance data.

26. The computer-implemented method of claim 21, wherein the one or more distance sensors are mounted to a dock.

27. The computer-implemented method of claim 21, wherein analysing the image data to identify the waterline comprises performing instance segmentation on the image data.

28. The computer-implemented method claim 21, further comprising obtaining the image data from at least one image sensor mounted to a dock.

29. The computer-implemented method claim 21, wherein the at least one object detected in the image data comprises at least two draft marks.

30. The computer-implemented method of claim 29, wherein the at least two draft marks are on the same side of the vessel, and the method further comprises calculating the trim of the vessel.

31. The computer-implemented method of claim 21, further comprising:
identifying a trackable feature of the vessel using one or more distance sensors (such as LIDAR sensors); and
calculating a height of the vessel based on the trackable feature.

32. The computer-implemented method of claim 31, wherein the trackable features is selected from any one of more of: a top edge of the vessel; draft marks of the vessel; and a physical feature of the vessel, including the transom.

33. The computer-implemented method of claim 27, wherein the instance segmentation is performed using a Mask R-CNN machine classifier.

34. The computer-implemented method of claim 21, wherein the at least one object is detected using a Faster R-CNN machine classifier.

35. A survey system for calculating the draft of a vessel, comprising:
one or more image sensors to obtain image data of a vessel;
one or more distance sensors to obtain distance data of a hull of the vessel; and
a controller in communication with the one or more image sensors and the one or more distance sensors, configured to determine an angle of list of the vessel based on the distance data, and to calculate the draft of the vessel based on the image data and the distance data.

36. The survey system of claim 35, wherein the controller is configured to:
detect at least one object in the image data, the at least one object comprising at least one draft mark,
identify a waterline by analysing the image data,
determine an intersection between the at least one draft mark and the waterline, and
calculate the draft of the vessel based on the at least one draft mark and the intersection.

37. The survey system of claim 35, wherein the distance data comprises LIDAR data, and the one or more distance sensors comprise one or more LIDAR sensors.

38. The survey system of any one of claim 35, wherein the controller is further configured to determine a height of the vessel, and wherein the draft of the vessel is further calculated based on the waterline and the height, whereby the height may be used as a redundancy during periods where the draft cannot be determined from the image data.

39. A computer-implemented method comprising:
receiving image data of a vessel from at least one image sensor,
detecting at least one object in the image data, the at least one object comprising at least one draft mark,
identifying a waterline by analysing the image data,
determining an intersection between the at least one draft mark and the waterline,
receiving distance data of the vessel from one or more distance sensors;
determining an angle of list of the vessel based on the one or more distance sensors; and
calculating the draft of the vessel based on the at least one draft mark and the intersection, and the angle of list.

40. The computer-implemented method of claim 39, wherein the distance data comprises LIDAR data and the one or more distance sensors comprise one or more LIDAR sensors.

41. The computer-implemented method of claim 39, further comprising determining a height of the vessel, and calculating the draft of the vessel based on the waterline and the height, whereby the height may be used as a redundancy during periods where the draft cannot be determined from the image data.

42. A computer system comprising:
a memory, and
at least one processor configured to perform the method of claim 21.
